(19) United States
(12) Patent Application Publication
(10) Pub. No.: US 2018/0288007 A1
(43) Pub. Date: Oct. 4, 2018

(54) TECHNOLOGIES FOR ANONYMIZING SENSOR DATA OF AN INTERNET-OF-THINGS SENSOR CLOUD

(71) Applicants: Rajesh Poornachandran, Portland, OR (US); Ned M. Smith, Beaverton, OR (US); Micah J. Sheller, Hillsboro, OR (US); Ravikiran Chukka, Portland, OR (US)

(72) Inventors: Rajesh Poornachandran, Portland, OR (US); Ned M. Smith, Beaverton, OR (US); Micah J. Sheller, Hillsboro, OR (US); Ravikiran Chukka, Portland, OR (US)

(21) Appl. No.: 15/476,991

(22) Filed: Apr. 1, 2017

(51) Int. Cl. H04L 29/06; G06F 21/62; H04W 12/02

(52) U.S. Cl. CPC H04L 63/0421; H04W 12/02; G06F 21/6263; G06F 21/6254

(57) ABSTRACT

Technologies for anonymizing sensor data of an Internet-of-Things (IOT) sensor cloud include receiving sensor data from an IOT sensor of the sensor cloud and determining a mapping for the sensor data that identifies one or more processes to be applied to the sensor data to convert the sensor data to synthetic data, which includes less personal identifiable characteristics of the user than the sensor data. The sensor data is synthesized using the determined mapping to generate the synthetic data, which is subsequently transmitted to a remote service for processing. Responses from the remote service may be de-synthetized to produce personalized responses for the user using the determined mapping.

### BACKGROUND

The Internet-of-Things (“IOT”) is a concept of an inter-connected network of “smart” objects or devices, each of which is embedded with hardware and/or software that enable connectivity to the network. An object, device, sensor, or “thing” (also referred to as an “IOT device”) that is connected to a network typically provides information to a manufacturer, operator, and/or other connected devices in order to track usage of the object and/or obtain services.

In use, IOT devices may collect user's data, for example, audio and/or video data of the user that may include the user's privacy sensitive information such as the user's personal identifiable characteristics. The collected data is transmitted to a corresponding cloud service, where the user's data may be stored, processed, and analyzed by the cloud service to provide a remote service to the user. Of course, it should be appreciated that the enormous amount of user's privacy sensitive data that is collected by IOT devices is out of the user's control once the data is transmitted to the cloud services. Given that cloud data servers are not hacker proof, user's data residing in any cloud is at risk.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of an internet-of-things (IOT) system;

FIG. 2 is a simplified block diagram of at least one embodiment of an environment that may be established by an IOT gateway device of the system of FIG. 1;

FIGS. 3 and 4 are a simplified flow diagram of at least one embodiment of a method for adjusting or setting privacy settings associated with IOT sensor devices and/or IOT sensor data that may be executed by the IOT gateway device of FIGS. 1 and 2;

FIGS. 5 and 6 are simplified flow diagram of at least one embodiment of a method for anonymizing sensor data produced by the IOT sensor devices that may be executed by the IOT gateway device of FIGS. 1 and 2; and

FIG. 7 is simplified flow diagram of at least one embodiment of a method for de-anonymizing a response received from a remote service to generate a personal response that may be executed by the IOT gateway device of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

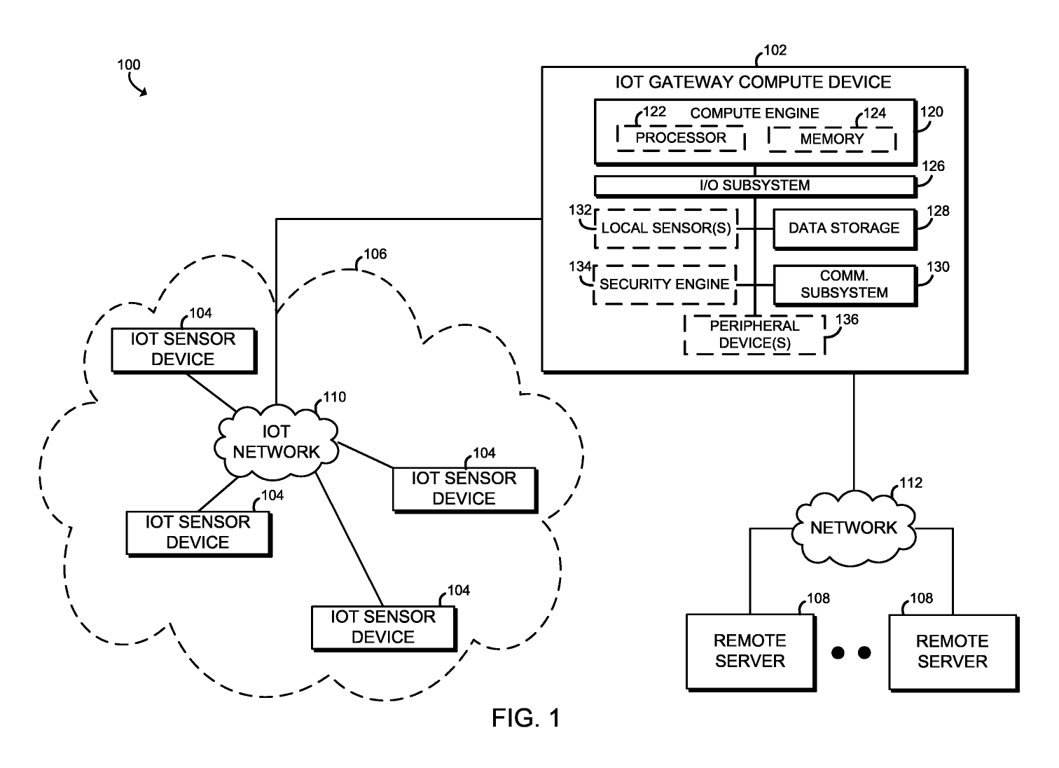

Referring now to FIG. 1, an illustrative system 100 for anonymizing sensor data produced by an Internet-of-Things (IOT) sensor cloud or fog 106 includes an IOT gateway compute device 102 and one or more IOT sensor devices 104, which form the IOT cloud 106. In use, the IOT sensor devices 104 are configured to collect sensor data that may include user's personal identifiable characteristics (e.g., user's voice, image, expression) and transmit the sensor data to the IOT gateway compute device 102 through an IOT network 110. As discussed in more detail below, the IOT gateway compute device 102 is configured to monitor and control communication between one or more IOT sensor devices 104 and one or more remote servers 108. In the illustrative embodiments, the IOT gateway compute device 102 is configured to anonymize the sensor data by synthesizing the sensor data to convert the sensor data to synthetic data by removing user's personal identifiable characteristics. That is, the synthetic data includes less personal identifiable characteristics than the sensor data. The synthetic data is transmitted to a corresponding remote service, which is performed by one or more of the remote servers 108, to be further analyzed and stored for the remote service to provide corresponding services to IOT sensor devices 104.

The IOT gateway compute device 102 may be embodied as any type of gateway, router, switch, or other compute device capable performing the functions described herein. For example, the IOT gateway compute device 102 may be embodied as a router or other type of networked peripheral device that has its own IP address that is recognizable by devices on both the IOT network 110 and the network 112. As shown in FIG. 1, the illustrative IOT gateway compute device 102 includes a compute engine 120, an input/output (“I/O”) subsystem 126, a data storage 128, and a communication subsystem 130. In some embodiments, the IOT gateway compute device 102 may further include one or more local sensors 132, a security engine 134, and/or one or more peripheral devices 136. It should be appreciated that the IOT gateway compute device 102 may include other or additional components, such as those commonly found in a typical computing device (e.g., various input/output devices and/or other components), in other embodiments. Additionally, in some embodiments, one or more of the illustrative components may be incorporated in, or otherwise form a portion of, another component. For example, the memory 124, or portions thereof, may be incorporated in the processor 122 in some embodiments.

The compute engine 120 may be embodied as any type of device or collection of devices capable of performing various compute functions as described below. In some embodiments, the compute engine 120 may be embodied as a single device such as an integrated circuit, an embedded system, a field-programmable-array (FPGA, a system-on-a-chip (SOC), or other integrated system or device. In some embodiments, the compute engine 120 includes or is embodied as a processor 122 and memory 124. The processor 122 may be embodied as any type of processor capable of performing the functions described herein. For example, the processor 122 may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the IOT gateway compute device 102 such as operating systems, applications, programs, libraries, and drivers. The memory 124 is communicatively coupled to the processor 122 via the I/O subsystem 126, which may be embodied as circuitry and/or components to facilitate input/output operations with the processor 122, the memory 124, and other components of the IOT gateway compute device 102. For example, the I/O subsystem 126 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 126 may be incorporated, along with the processor 122, the memory 124, and other components of the IOT gateway compute device 102, into the compute engine 120.

The data storage 128 may be embodied as any type of device or devices configured for short-term or long-term storage of data such as, for example, memory devices and circuits, memory cards, hard disk drives, solid-state drives, or other data storage devices. As discussed in detail below, the IOT gateway compute device 102 may store sensor data received from IOT sensor devices 104 of the IOT cloud 106, privacy settings associated with IOT sensor devices 104 or sensor data, sensor data-to-synthetic data mapping, and/or synthetic data logs in the data storage 128. As discussed in more detail below, the synthetic data is generated based, at least in part, on the privacy settings and the sensor data-to-synthetic data mapping stored in the data storage 128.

The communication subsystem 130 may be embodied as any type of communication circuit, device, or collection thereof, capable of enabling communications between the IOT gateway compute device 102 and other devices of the system 100 (e.g., the IOT sensor devices 104 via the IOT network 110 or the remote servers 108 via the network 112). To do so, the communication subsystem 130 may be configured to use any one or more communication technologies (e.g., wireless or wired communications) and associated protocols (e.g., Ethernet, Bluetooth®, Wi-Fi®, WiMAX, LTE, 5G, etc.) to effect such communication.

The local sensors 132 may be similar to the IOT sensor devices 104 and may be embodied as any type of sensor capable of capturing sensor data that may include personal identifiable characteristics of the user, such as the user's voice, user's image, image of the surrounding of the user, background audio, user's activity history, user's preferences, and so forth. For example, the local sensors 132 may be embodied as any type of audio capture device capable of capturing audio local to the IOT gateway compute device 102. In such example, the audio sensor may include, or otherwise embodied as, a microphone that captures a user's voice. In another example, the local sensors 132 may be embodied as any type of image capture device capable of capturing images local to the IOT gateway compute device 102. In such example, the image sensor may include, or otherwise embodied as, a camera or a video camera that captures a user's image or gesture. It should be appreciated that the collected sensor data may be stored in the data storage 128 of the IOT gateway compute device 102.

The security engine 134 may be embodied as any hardware component(s) and/or software component (e.g., processor instructions extensions) capable of establishing a trusted execution environment (TEE) on the IOT gateway compute device 102. In particular, the security engine 134 may support executing code and/or storing/accessing data that is independent and secure from other code and/or data executed by the IOT gateway compute device 102. For example, the data storage 128, or a portion thereof, may be protected by or form a portion of the security engine 134 such that the data storage 128 is embodied as a secure tamper resistant storage. In some embodiments, the security engine 134 may be included or form a portion of the compute engine 120 (e.g., the processor 122). It should be appreciated that the security engine 134 and/or compute engine 120 may utilize any suitable technology to established the trusted execution environment including, for example, Intel® Software Guard Extensions (SGX), Trusted Execution Engine (TEE), Trusted Platform Module (TPM), Intel® Converged Security Engine (CSE), ARM® TrustZone®, Intel® Manageability Engine, Intel® Chaabi Security Engine, Intel® virtualization instructions, and/or other techniques and mechanisms for the security engine 134 and/or compute engine 120 for establishing a secure and trusted execution environment.

The peripheral devices 134 may include any number of additional peripheral or interface devices, such as other input/output devices, storage devices, and so forth. The particular devices included in the peripheral devices 134 may depend on, for example, the type and/or configuration of the IOT gateway compute device 102, the IOT sensor devices 104, and/or the remote service.

Each IOT sensor device 104 may be embodied as any device capable of capturing sensor data that may include personal identifiable characteristics of a user. As discussed above, such sensor data may include data that can directly identify the user such as the user's voice, image, location, address, and/or the like and/or other data that may be used to identify characteristics of the user such as an image of the user's surrounding, background audio, user's activity history, user's preferences, and/or the like. Each IOT sensor device 104 may be embodied as an individual sensor or sensor device capable of capturing such sensor data. For example, one or more IOT sensor devices 104 may be embodied as a microphone, camera, or other sensor. Alternatively, each IOT sensor device may be embodied as a “smart” device that includes a sensor capable of capturing such sensor data. For example, one or more IOT sensor devices 104 may be embodied as a smart consumer electronic device, a smart home appliance, a security camera device, a smart audio device, a smart home automation device, a smartphone, a tablet computer, a laptop computer, a notebook, desktop computer, and/or other smart compute device. In such embodiments, the IOT sensor device 104 is configured to collect sensor data based on the sensor(s) included in the IOT sensor device 104. For example, the IOT sensor device 104 may include an audio sensor that may be embodied as any type of audio capture device capable of capturing audio local to the IOT sensor device 104. In such an example, the audio sensor may include, or otherwise embodied as, a microphone that captures a user's voice. In another example, the IOT sensor device 104 may include an image sensor that may be embodied as any type of image capture device capable of capturing image local to the IOT sensor device 104. In such an example, the image sensor may include, or otherwise embodied as, a camera or a video camera that captures a user's image or gesture. Each IOT sensor device 104 is configured to transmit the collected sensor data to the IOT gateway compute device 102 via the IOT network 110.

The IOT network 110 may be embodied as any type of local network capable of facilitating communications between the IOT sensor device 104 and the IOT gateway compute device 102. For example, the IOT network 110 may be embodied as, or otherwise include, a wireless or wired local area network (LAN), a wireless or wired wide area network (WAN), a personal network, a Bluethooth® network, or other local network. As such, the IOT network 110 may include any number of additional devices, such as additional computers, routers, and switches, to facilitate communications thereacross.

The IOT gateway compute device 102 is configured to transmit the sensor data and/or the synthetic data to a remote service (e.g., a cloud service) provided by one or more of the remote servers 108. To do so, the IOT gateway compute device 102 may communicate with the one or more remote servers 108 via the network 112 to transmit the sensor data produced by the IOT sensor device 104 or the synthetic data converted from the sensor data by the IOT gateway compute device 102 as discussed in more detailed below. The remote server 108 may analyze and store the received sensor data and provide various services based on such analysis, such as voice-activated services, gesture-based services, and/or any other service based on the sensor/synthetic data provided by the IOT gateway compute device 102. The remote server 108 may be embodied as any type of computation or computer device capable of performing the functions described herein including, without limitation, a computer, a multiprocessor system, a rack-mounted server, a blade server, a laptop computer, a notebook computer, a tablet computer, a wearable computing device, a network appliance, a web appliance, a distributed computing system, a processor-based system, and/or a consumer electronic device. It should be appreciated that the remote server 108 may be embodied as a single compute device or a collection of distributed compute devices and may include components, such as a processor and memory, similar to the IOT gateway compute device 102, the description of which is not repeated herein for clarity of the description.

The network 112 may be embodied as any type of network capable of facilitating communications between the IOT gateway compute device 102 and the remote servers 108. For example, the network 112 may be embodied as, or otherwise include, a wired or wireless local area network (LAN), a wired or wireless wide area network (WAN), a cellular network, and/or a publicly-accessible, global network such as the Internet. As such, the network 112 may include any number of additional devices, such as additional computers, routers, and switches, to facilitate communications thereacross.

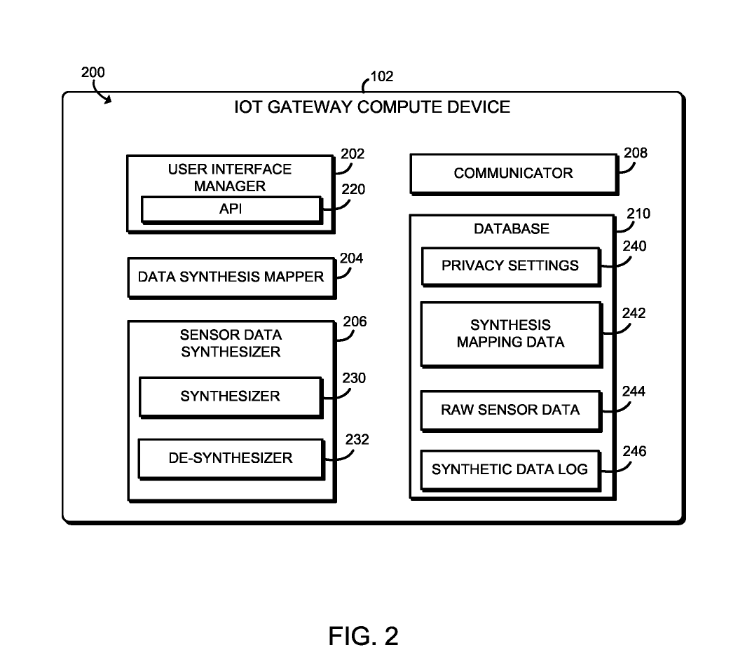

Referring now to FIG. 2, in use, the IOT gateway compute device 102 may establish an environment 200 for anonymizing sensor data received from the IOT sensor devices 104 of the IOT cloud 106. The illustrative environment 200 includes a user interface manager 202, a data synthesis mapper 204, a sensor data synthesizer 206, a communicator 208, and a database 210. The various components of the environment 200 may be embodied as hardware, firmware, software, or a combination thereof. As such, in some embodiments, one or more of the components of the environment 200 may be embodied as circuitry or collection of electrical devices (e.g., a user interface manager circuit 202, a data synthesis mapper circuit 204, a sensor data synthesizer circuit 206, a communicator circuit 208, etc.). It should be appreciated that, in such embodiments, one or more of the user interface manager circuit 202, the data synthesis mapper circuit 204, the sensor data synthesizer circuit 206, and/or the communicator circuit 208 may form a portion of one or more of the compute engine 120, the processor 122, the I/O subsystem 126, the communication subsystem 130, and/or other components of the IOT gateway compute device 102. Additionally, in some embodiments, one or more of the illustrative components of the environment 200 may form a portion of another component and/or one or more of the illustrative components may be independent of one another. Further, in some embodiments, one or more of the components of the environment 200 may be embodied as virtualized hardware components or emulated architecture, which may be established and maintained by the compute engine 120 or other components of the IOT gateway compute device 102.

The user interface manager 202 is configured to provide a user interface (e.g., graphical user interface) that allows the user to set or adjust one or more privacy settings (i.e., a level of privacy) associated with the sensor data or particular IOT sensor devices 104. For example, the privacy settings may indicate a desired amount of personal identifiable characteristics of a user to be removed from, or acceptable to be included in, the sensor data produced by a particular IOT sensor device 104 or all sensor data of a particular type. In some embodiments, for example, the user may individually choose one or more privacy settings associated with each IOT sensor device 104. In other embodiments, the user may choose one or more privacy settings associated with a group of related IOT sensor devices 104. For example, the user may choose the privacy settings to be applied to all IOT sensor devices 104 associated with a user's home security system. Alternatively, the user may choose the privacy settings to be applied to all IOT sensor devices 104 of a particular type. For example, the user may set the privacy settings that are to be applied to all audio IOT sensor devices. In yet some embodiments, the user may choose the privacy settings to be applied to a type of sensor data (e.g., audio or image data) produced by various IOT sensor devices 104. In yet other embodiments, the user may choose the privacy settings to be applied to the IOT sensor devices 104 based on the type of service sought from the remote server 108 (e.g., privacy settings to be applied to all sensor data transmitted to that particular service). It should be appreciated that the IOT gateway compute device 102 further determines whether the desired privacy settings are valid, which is discussed in more detail below.

To set or adjust one or more privacy settings, the user interface manager 202 may include an application programming interface (API) 220 in some embodiments. The API 220 allows interfacing with one or more IOT sensor devices 104 of the IOT cloud 106. In such embodiments, an IOT sensor device 104 may provide the possible privacy settings associated with the IOT sensor device 104 or the sensor data produced by the IOT sensor device 104 that may be set or adjusted by the user.

The data synthesis mapper 204 is configured to determine whether to synthesize the sensor data received from an IOT sensor device 104 to remove or reduce personal identifiable characteristics included in the raw sensor data. To do so, in some embodiments, the data synthesis mapper 204 may determine whether to synthesize the sensor data based on the privacy settings associated with the received sensor data or the IOT sensor device 104. In other embodiments, the data synthesis mapper 204 may determine an identification indicator of the IOT sensor device 104 and compare the identification to privacy settings 240 stored in the database 210 to determine whether the received sensor data requires synthesizing, which is discussed in detail below.

If a particular sensor data requires synthesizing, the data synthesis mapper 204 is also configured to determine a sensor data-to-synthetic data mapping for the sensor data in response to a determination that the sensor data requires synthesizing. It should be appreciated that the mapping identifies one or more processes that are to be applied to the sensor data to convert the sensor data to synthetic data. As discussed above, the synthetic data includes fewer (or none) personal identifiable characteristics of the user relative to the sensor data. In some embodiments, the mapping processes may include algorithms that determine and remove or replace the personal identifiable characteristics of the user. In other embodiments, the mapping processes may include identifications of types of information in the sensor data that needs to be removed or replaced in order to reduce or remove the personal identifiable characteristics of the user.

The data synthesis mapper 204 may determine the particular processes to be applied to the sensor data based on any suitable criteria. For example, in some embodiments, the data synthesis mapper 204 determines one or more processes to be applied to the sensor data based on an identification indicator of a particular IOT sensor device 104, a type of the IOT sensor device 104, a type of the sensor data, and/or a type of service sought from the remote server 108. For example, in some embodiments, a mapping of audio data may include removing all frequencies of the audio data that are above a predefined frequency level. In some embodiments, a mapping of an image data of a user may include replacing the user's face with another person's face selected from a reference database (e.g., a database of actors' faces) that has the same facial expression as the user's facial expression. In other embodiments, the mapping of the user's image data may include replacing the user's face with a generic face and altering the facial expression of the generic face to match the user's facial expression. In yet other embodiments, the mapping of the user's image data may include replacing the user's face with an artificial face, such as an emoticon, that matches the user's facial expression. It should be appreciated that, in some embodiments, the mapping processes or the synthesis mapping data 242 may be predefined and stored in the database 210 based on a type of the IOT sensor device 104, a type of the sensor data, an identification indicator of the IOT sensor device 104, and/or a type of remote service. For example, some IOT sensor devices 104 may notify the IOT gateway compute device 102 which processes may be utilized via the API 220. In such embodiments, the data synthesis mapper 204 selects the corresponding mapping from the synthesis mapping data 242 stored in the database 210.

The sensor data synthesizer 206 illustratively includes a synthesizer 230 and a de-synthesizer 232. The synthesizer 230 is configured to synthesize the sensor data received from an IOT sensor device 104 to generate the synthetic data using the synthesis mapping determined by the data synthesis mapper 204. To do so, the synthesizer 230 may perform the one or more processes defined by the determined mapping on the sensor data. In some embodiments, the synthesizer 230 may replace the sensor data with generic data of the same sensor data type as the sensor data. For example, the synthesizer 230 may replace biometric data of the user with biometric data of another person. If the biometric data of the user is image data that captured the facial expression of the user, the synthesizer 230 may apply the mapping determined by the data synthesis mapper 204 to replace an image of the user with a smiley face with a generic person with a smiley face or an image of the user with a frown face with a generic person with a frown face to produce synthetic data. It should be appreciated that the generic data is stored in the database 210. As discussed above, in some embodiments, the synthesizer 230 may replace the sensor data with artificial sensor data of the same sensor data type as the sensor data. For example, instead of selecting generic images of another person stored in the database 210, the synthesizer 230 may replace the sensor data with machine generated synthetic data stored in the database 210. In the example above, the synthesizer 230 may replace the image of the user with the smiley face with a smiley emoticon, and the image of the user with the frown face with a frown emoticon. It should be appreciated that regardless how the sensor data is synthesized, the synthesizer 230 is configured to remove a desired amount of personal identifiable characteristics of the user from the sensor data. For example, the synthesizer 230 may remove the personal identifiable characteristics from the sensor data that are not required by the remote service to provide a corresponding service or response. In some embodiments, the synthesizer 230 is further to log the synthetic data and the identification indicator of the corresponding IOT sensor device 104 in the synthetic data log 246 stored in the database 210. As discussed below, the synthetic data log 246 is configured to identify the mapping used to generate the synthetic data associate with the identification indicator of the IOT sensor device 104.

The de-synthesizer 232 is configured to determine whether a response from the remote server 108 in response to receiving the synthetic data requires de-synthesizing based on the synthetic data log 246. In response to a determination that the response requires de-synthesizing, the de-synthesizer 232 is configured to determine the mapping that was used to generated the synthetic data based on the synthetic data log 246 stored in the database 210. Based on the determined mapping, the de-synthesizer 232 converts the received response to a personalized response, which is then provided to the corresponding IOT sensor device 104 by the communicator 208.

The communicator 208 is configured to facilitate communications between the one or more IOT sensor devices 104 and the one or more remote servers 108 of the corresponding remote service. In the illustrative embodiment, the communicator 208 is configured to receive sensor data from the IOT sensor devices 104 of the IOT sensor cloud 106 and transmit the synthetic data to the remote server 108 for processing and/or storage. In the illustrative embodiment, the communicator 208 further receives a response from the remote server 108 in response to receiving the synthetic data. It should be appreciated that, in some embodiments, the communicator 208 may transmit raw sensor data to one or more remote servers 108 of the remote service.

The database 210 includes a privacy settings 240, synthesis mapping data 242, raw sensor data 244, and synthetic data log 246. As discussed above, the privacy settings 240 may be predefined based on a type of the IOT sensor device 104, a type of sensor included in the IOT sensor device 104, a type of the sensor data from the database 210, an identification indicator of the IOT sensor device 104, user profile, and/or a type of the remote service. Alternatively, the privacy settings 240 may be selected by the user. As discussed above, some or all of the data stored in the database 210 may be stored in a tamper resistant storage available in Trusted Execution Environment (TEE) established or maintained by the security engine 134 to provide security to that data (e.g., to the synthesis mapping data).

The synthesis mapping data 242 includes one or more processes that may be applied to the sensor data produced by the IOT sensor devices 104 to remove the unnecessary or undesired personal identifiable characteristics of the user. As discussed above, the sensor data-to-synthetic data mapping may be predefined based on a type of the IOT sensor device 104, a type of sensor included in the IOT sensor device 104, a type of the sensor data from the database 210, an identification indicator of the IOT sensor device 104, and/or a type of the remote service.

The raw sensor data 244 includes the sensor data produced by the IOT sensor devices 104 of the IOT cloud 106 that have not been synthesized. In some situations, the raw sensor data 244 may be provided to a remote service (e.g., due to the raw sensor data including no or little personal identifiable characteristics, the remote service requiring the raw data to perform the server, etc.)

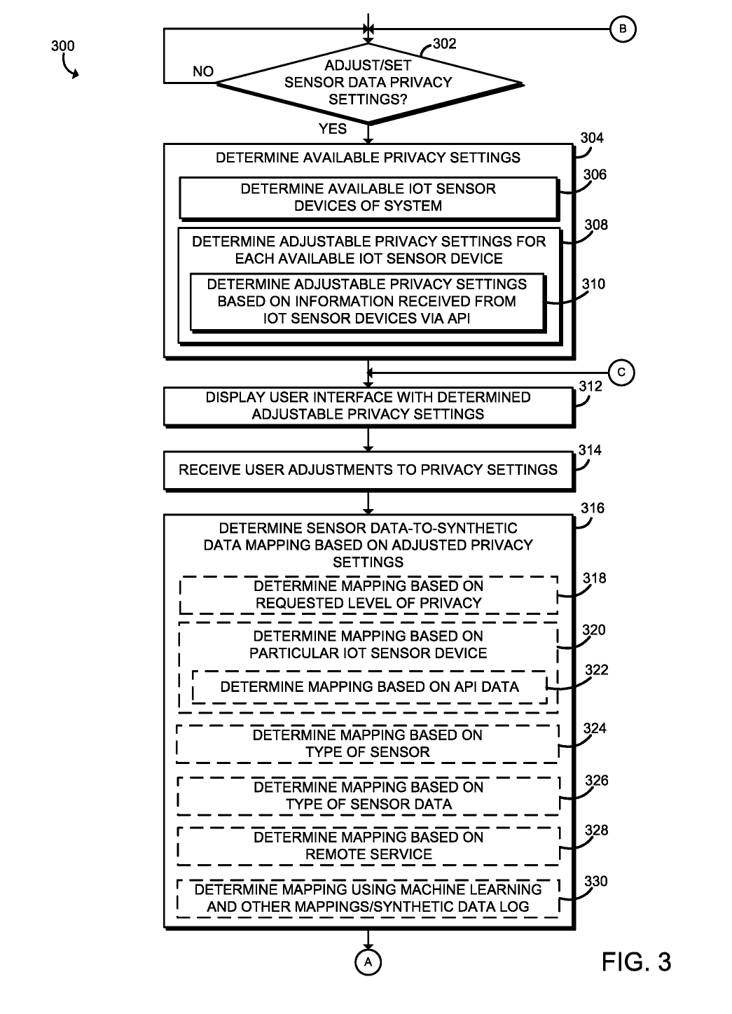

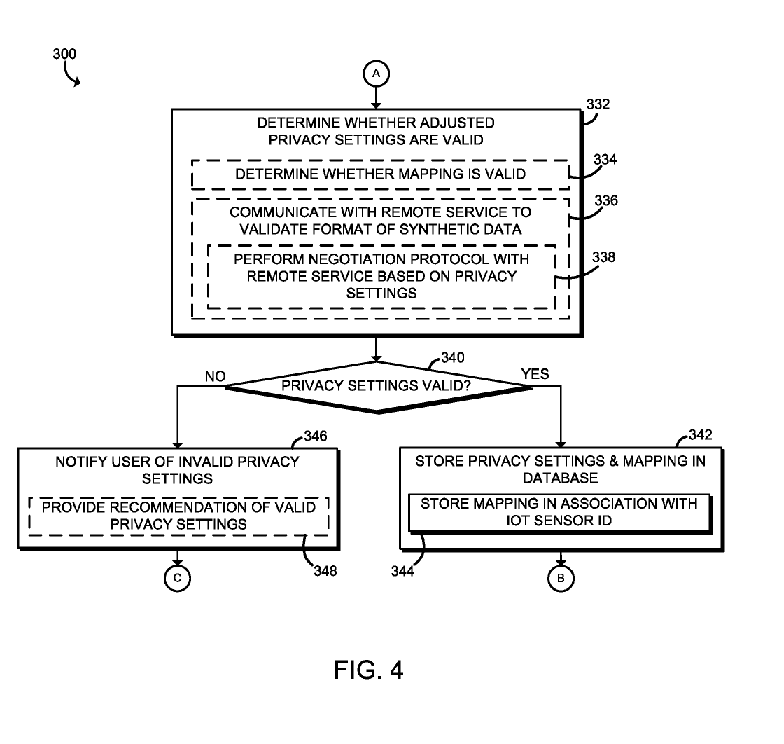

Referring now to FIGS. 3 and 4, in use, the IOT gateway compute device 102 may execute a method 300 for adjusting or setting privacy settings, which define which and to what degree particular sensor data is to be anonymized. As discussed above, the privacy settings may be associated with an individual IOT sensor device 104, the type of IOT sensor devices 104, the type of sensor data, and/or a type of service sought from the remote server 108. The method 300 begins with block 302 in which the IOT gateway compute device 102 determines whether a user desires to adjust or set the privacy settings of one or more IOT sensor data devices 104 of the IOT cloud 106. If the IOT gateway compute device 102 determines that no adjustment or setting of the privacy settings is desired, the method 300 loops back to block 302 to continue monitoring the privacy settings of one or more IOT sensor devices 104 in the system 100 and determining whether the user desires to adjust or set the privacy settings of one or more IOT sensor data devices 104. If, however, the IOT gateway compute device 102 determines to adjust or set the privacy setting of one or more IOT sensor data devices 104, the method 300 advances to block 304.

In block 304, the IOT gateway compute device 102 determines the privacy settings that are available to be adjusted or set. For example, the privacy settings may indicate a different level of personal identifiable characteristics of the user to be removed from the sensor data produced by the IOT sensor device 104. To do so, in block 306, the IOT gateway compute device 102 determines which IOT sensor devices 104 are available in the system 100. In block 308, the IOT gateway compute device 102 determines which privacy settings are adjustable for each of the available IOT sensor devices 104. In some embodiments, in block 310, the IOT gateway compute device 102 may determine the adjustable privacy settings based on the information received from the IOT sensor devices 104 via the API 220. As discussed above, the IOT sensor device 104 may provide the privacy settings of the IOT sensor device 104 and/or the sensor data produced by the IOT sensor device 104 that are adjustable by the user. In some embodiments, the IOT gateway compute device 102 may determine the adjustable privacy settings by determining the identification indicator of the IOT sensor device 104 and selecting the privacy settings 240 stored in the database 210 that match the identification.

In block 312, the IOT gateway compute device 102 displays a user interface with the determined adjustable privacy settings to the user to allow the user to select and adjust the privacy settings. As discussed above, the user may choose to adjust the privacy settings to be applied to a particular IOT sensor device 104, a type of IOT sensor device 104, or a type of sensor data. In some embodiments, the user may choose to adjust the privacy settings based on the type of remote service sought from one or more remote sensors 108. In block 314, the IOT gateway compute device 102 receives the user adjustments to the privacy settings.

In block 316, the IOT gateway compute device 102 determines a sensor data-to-synthetic data mapping for each adjusted privacy setting. As discussed above, the sensor data-to-synthetic data mapping includes one or more processes to be applied to the sensor data to generate synthetic data for that particular sensor data. To do so, in some embodiments, in block 318, the IOT gateway compute device 102 may determine the mapping based on the requested level of privacy selected by the user. In some embodiments, in block 320, the IOT gateway compute device 102 may determine the mapping based on the IOT sensor device 104. For example, in some embodiments, one or more IOT sensor devices 104 may provide its predefined mapping to the IOT gateway compute device 102 via the API 220 that is to be applied to the sensor data produced by the corresponding IOT sensor device 104. In such embodiment, in block 322, the IOT gateway compute device 102 determines the mapping based on the API data that includes predefined mappings of one or more IOT sensor devices 104. In other embodiments, the IOT gateway compute device 102 may determine the mapping based on a type of IOT sensor device 104 (e.g., an audio or image sensor) in block 324. In yet other embodiments, the IOT gateway compute device 102 may determine the mapping based on a type of sensor data (e.g., audio or image data) in block 326. Additionally, in other embodiments, the IOT gateway compute device 102 may determine the mapping based on the remote service sought from the remote server 108. Furthermore, in some embodiments, the IOT gateway compute device 102 may determine the mapping using a machine learning algorithm and other or previously determined mappings and/or the synthetic data log 246 in block 330. That is, the IOT gateway compute device 102 may determine a new mapping based on previous mappings and operations that have worked or otherwise been acceptable in the past by the remote service. To do so, the IOT gateway compute device 102 may utilize any suitable machine learning algorithm and may perform such machine learning continually, periodically, or on an as-needed basis to determine new mappings.

It should be appreciated that, in some embodiments, one or more blocks 318-330 may be performed by the IOT gateway compute device 102 to determine the mapping based on the adjusted privacy settings. Additionally, in some embodiments, the determination and storage of the sensor data-to-synthetic data mapping may be performed in a Trusted Execution Environment (TEE) established or maintained by the security engine 134.

After the IOT gateway compute device 102 has determined the various mappings in block 316, the method 300 advances to block 332 of FIG. 4. In block 332, the IOT gateway compute device 102 determines whether the adjusted privacy settings are valid. To do so, in some embodiments, the IOT gateway compute device 102 may determine whether the sensor data-to-synthetic data mapping determined based on the adjusted privacy settings is valid in block 334. For example, the IOT gateway compute device 102 may determine whether synthetic data that satisfies the adjusted privacy settings can be produced by applying the determined mapping. In other words, the IOT gateway compute device 102 determines whether a desired level of personal identifiable characteristics can be removed from the sensor data to produce the synthetic data by applying the determined mapping.

In some embodiments, in block 336, the IOT gateway compute device 102 may communicate with the remote server 108 to validate a format of the synthetic data. To do so, the IOT gateway compute device 102 may transmit the synthetic data generated by applying the determined mapping based on the adjusted privacy settings to the remote server 108 to inquire whether the synthetic data includes enough information for the remote server 108 to provide the corresponding service. If the IOT gateway compute device 102 receives an error message from the remote server 108, the IOT gateway compute device 102 determines the privacy settings are invalid. If, however, the IOT gateway compute device 102 receives a response from the remote server 108 corresponds to the expected service, the IOT gateway compute device 102 determines that the privacy settings are valid. For example, in some embodiments in block 338, the IOT gateway compute device 102 and the remote service may engage in a negotiation protocol based on the privacy settings. During the negotiation protocol, the IOT gateway compute device 102 may negotiated the level of privacy obtainable while ensure the remote service can still perform its service. In this way, IOT gateway compute device 102 may establish the desired gradient of privacy-to-service.

In block 340, if the IOT gateway compute device 102 determines that the privacy settings are valid, the method 300 advances to block 342 in which the IOT gateway compute device 102 stores the privacy settings and associated mapping in the database 210. To do so, the IOT gateway compute device 102 stores the determined mapping in association with the identification indicator of the IOT sensor device 104 in block 344. In such embodiments, when the IOT gateway compute device 102 receives the sensor data from the IOT sensor device 104, the IOT gateway compute device 102 searches the synthesis mapping data 242 stored in the database 210 for the mapping that matches the identification indicator of the IOT sensor device 104 and uses the mapping to convert the sensor data to synthetic data. Subsequently, the method 300 loops back to block 302 to continue monitoring whether to adjust or set privacy settings of one or more IOT sensor devices 104.

If, however, the IOT gateway compute device 102 determines that the privacy settings are not valid, the method 300 advances to block 346 in which the IOT gateway compute device 102 notifies the user of invalid privacy settings. To do so, the identification indicator of the IOT sensor device 104 may provide recommendation of valid privacy settings in block 348. The method 300 then loops back to block 312 in which the IOT gateway compute device 102 displays the user interface with the adjustable privacy settings for user to re-select the privacy settings.

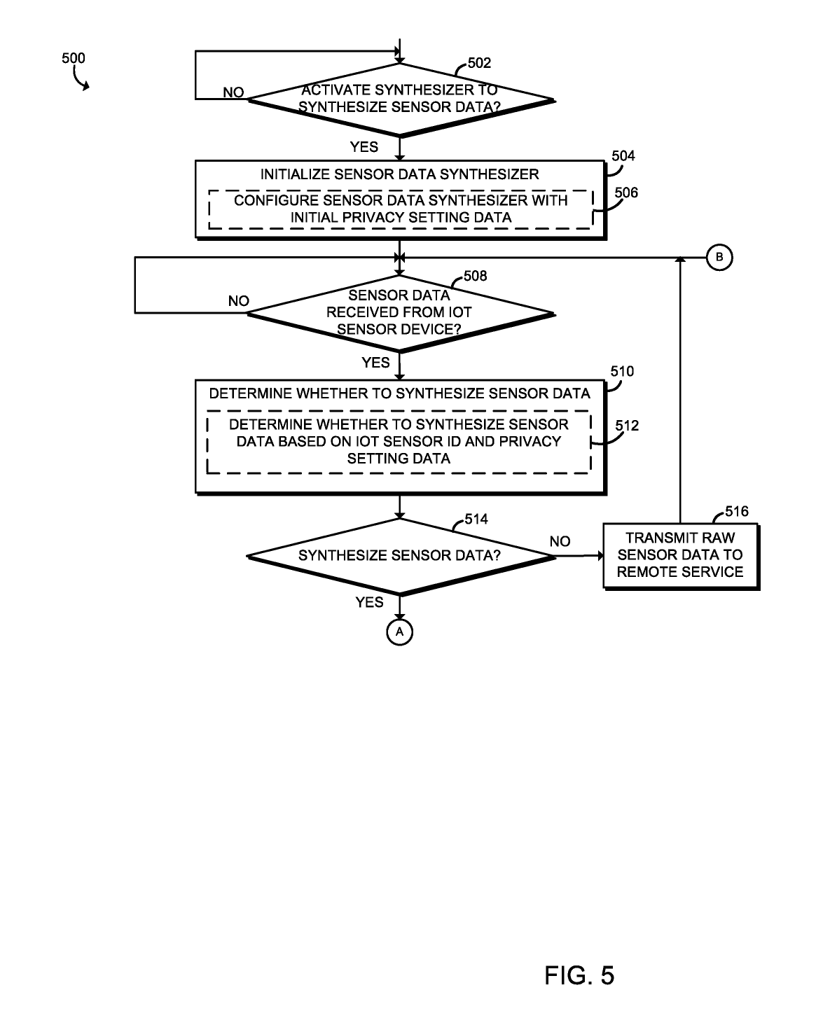

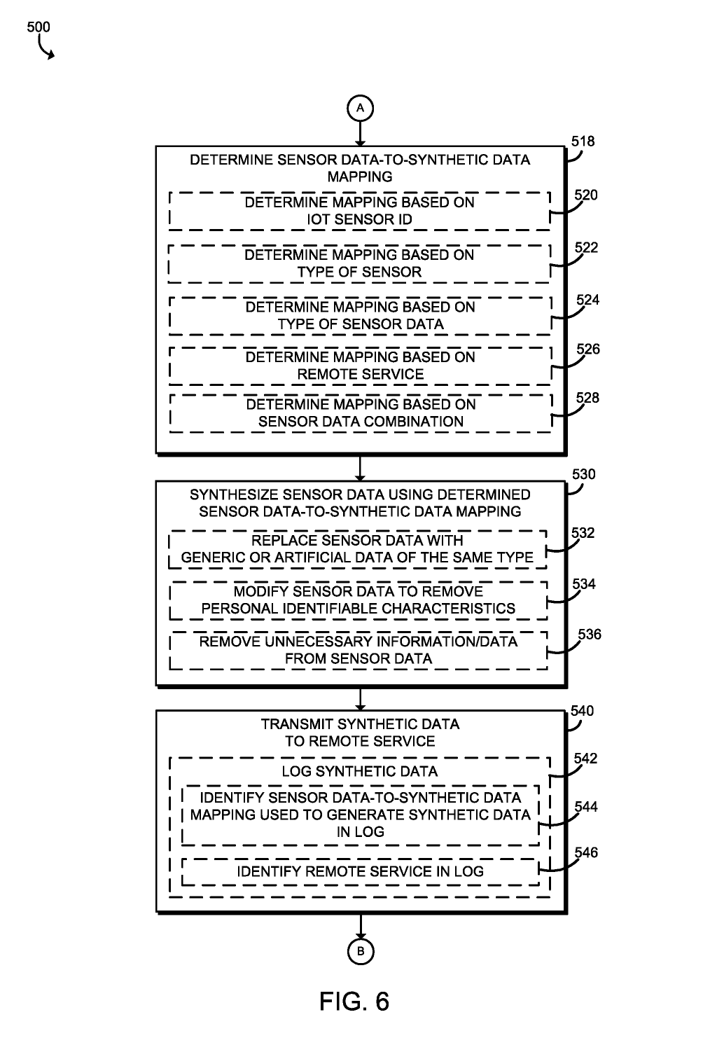

Referring now to FIGS. 5 and 6, in use, the IOT gateway compute device 102 may execute a method 500 for synthesizing sensor data received from an IOT sensor device 104 to produce synthetic data that includes fewer personal identifiable characteristics of the user relative to the raw sensor data. The method 500 begins with block 502 in which the IOT gateway compute device 102 determines whether to activate the synthesizer 230 to synthesize sensor data that may be received from an IOT sensor device 104. If the IOT gateway compute device 102 determines not to activate the synthesizer 230, the method 500 loops back to block 502 to continue determining whether to activate the synthesizer 230. If, however, the IOT gateway compute device 102 determines to activate the synthesizer 230, the method 500 advances to block 504.

In block 504, the IOT gateway compute device 102 initializes the synthesizer 230 in anticipation of synthesizing sensor data. To do so, in some embodiments, the IOT gateway compute device 102 may configure the synthesizer 230, in block 506, with initial privacy setting data such that the synthesizer 230 is equipped to synthesize sensor data received from one or more IOT sensor devices 104.

In block 508, the IOT gateway compute device 102 determines whether the IOT gateway compute device 102 received sensor data from an IOT sensor device 104. If not, the IOT gateway compute device 102 loops back to block 508 to continue waiting for sensor data from an IOT sensor device 104 to be received. If, however, the IOT gateway compute device 102 determines that the sensor data has been received from an IOT sensor device 104, the method 500 advances to block 510.

In block 510, the IOT gateway compute device 102 determines whether to synthesize the received sensor data. To do so, in some embodiments in block 512, the IOT gateway compute device 102 may determine whether to synthesize the sensor data based on the identification indicator of the IOT sensor device 104 and the privacy settings associated with the received sensor data or the IOT sensor device 104 that produced the received sensor data. For example, the IOT gateway compute device 102 may determine whether the user has adjusted the privacy settings to be applied to the IOT sensor device 104, a type of IOT sensor device 104 that matches the type of the IOT sensor device 104, a type of sensor data that matches the received sensor data, or a type of remote service that matches the remote service sought by the IOT sensor device 104. If the user has identified the adjusted privacy setting indicative of a desired amount of personal identifiable characteristics to be removed from the sensor data, the IOT gateway compute device 102 determines to synthesize the sensor data accordingly.

If the IOT gateway compute device 102 determines not to synthesize the sensor data in block 514, the method 500 advances to block 516 in which the IOT gateway compute device 102 transmits the raw sensor data received from the IOT sensor device 104 to the remote service. The method 500 then loops back to block 508 to continue waiting for sensor data to be received from an IOT sensor device 104.

If, however, the IOT gateway compute device 102 determines to synthesize the sensor data received from the IOT sensor device 104, the method 500 advances to block 518. In block 518, the IOT gateway compute device 102 determines a sensor data-to-synthetic data mapping to be applied to the received sensor data to convert the sensor data to the synthetic data. To do so, in some embodiments, in block 520, the IOT gateway compute device 102 determines the mapping based on the identification indicator of the IOT sensor device 104. As discussed above, the synthesis mapping data 242 stored in the database 210 includes a sensor data-to-synthetic data mapping in association with an identification indicator of an IOT sensor device 104. Accordingly, the IOT gateway compute device 102 may select the mapping associated with the identification indicator of the IOT sensor device 104 from the database 210.

In some embodiments, in block 522, the IOT gateway compute device 102 may determine the mapping based on the type of IOT sensor device 104. For example, if the IOT sensor device 104 is an audio sensor, the IOT gateway compute device 102 may determine the mapping that applies to all audio sensor devices of the IOT cloud 106. In yet some embodiments, in block 524, the IOT gateway compute device 102 may determine the mapping based on the type of sensor data. For example, if the received sensor data is an audio data, the IOT gateway compute device 102 may determine the mapping that applies to all audio data. In yet other embodiments, in block 526, the IOT gateway compute device 102 may determine the mapping based on the remote service sought from the remote server 108. For example, the IOT gateway compute device 102 may determine the mapping that applies to all sensor data that are seeking for the same remote service. In some embodiments, the IOT gateway compute device 102 may determine the mapping based on a combination of sensors or sensor data in block 528. That is, it should be appreciated that, while sensor data from a IOT sensor device 104 may not disclose or include a significant amount of personal identifiable characteristics, a particular combination of sensor data may. As such, the mapping may include a mapping for the combination of sensors or sensor data to remove or reduce the combined amount of personal identifiable characteristics.

After the IOT gateway compute device 102 has determined the mapping in block 518, the method 500 advances to block 530 of FIG. 6. In block 530, the IOT gateway compute device 102 synthesizes the received sensor data using the determined sensor data-to-synthetic data mapping. To do so, in some embodiments, in block 532, the IOT gateway compute device 102 may replace the sensor data with generic or artificial data of the same type to remove the personal identifiable characteristics of the user. For example, as discussed above, if the sensor data is image data that captured the facial expression of the user, the IOT gateway compute device 102 may apply the mapping to the sensor data to replace the user with a smiley face with a generic person with a smiley face or an image of the user with a frown face with a generic person with a frown face to produce synthetic data. Alternatively, the IOT gateway compute device 102 may replace the user with machine generated synthetic data stored in the database 210.

In some embodiments, in block 534, the IOT gateway compute device 102 may modify the sensor data to remove the personal identifiable characteristics of the user. For example, if the sensor data is an image data of the user, and the remote server 108 requires the image of the mouth of the user to determine the facial expression of the person to provide the corresponding remote service, the IOT gateway compute device 102 may modify the sensor data to remove all the facial features except the mouth of the user. Additionally, if the sensor data is an audio data, the IOT gateway compute device 102 may remove all audio frequencies that are below a predefined frequency level to remove the background noise that may include personal identifiable information.

In other embodiments, in block 536, the IOT gateway compute device 102 may remove the unnecessary information or data from the sensor data. The unnecessary information or data may be the information or data that may not be required by the remote service to provide the adequate service or response. For example, if the sensor data is an audio data, the IOT gateway compute device 102 may fragmentize the audio data into multiple audio fragments and removes the audio fragments that are not required by the remote service to provide the adequate service. Additionally, the IOT gateway compute device 102 may only include inflection points of the audio fragments that are necessary for the remote server 108 to further remove personal identifiable characteristics.

In block 540, the IOT gateway compute device 102 transmits the synthetic data to the corresponding remote service. In some embodiments, in block 542, the IOT gateway compute device 102 logs the synthetic data and stores the synthetic data log 246 in the database 210. To do so, in some embodiments, in block 544, the IOT gateway compute device 102 may further store the identification of the sensor data-to-synthetic data mapping used to generate the synthetic data in the log 246. In other embodiments, in block 546, the IOT gateway compute device 102 may further store the identification of the corresponding remote service in the log 246. The method 500 then loops back to block 508 to continue waiting for sensor data to be received from an IOT sensor device 104.

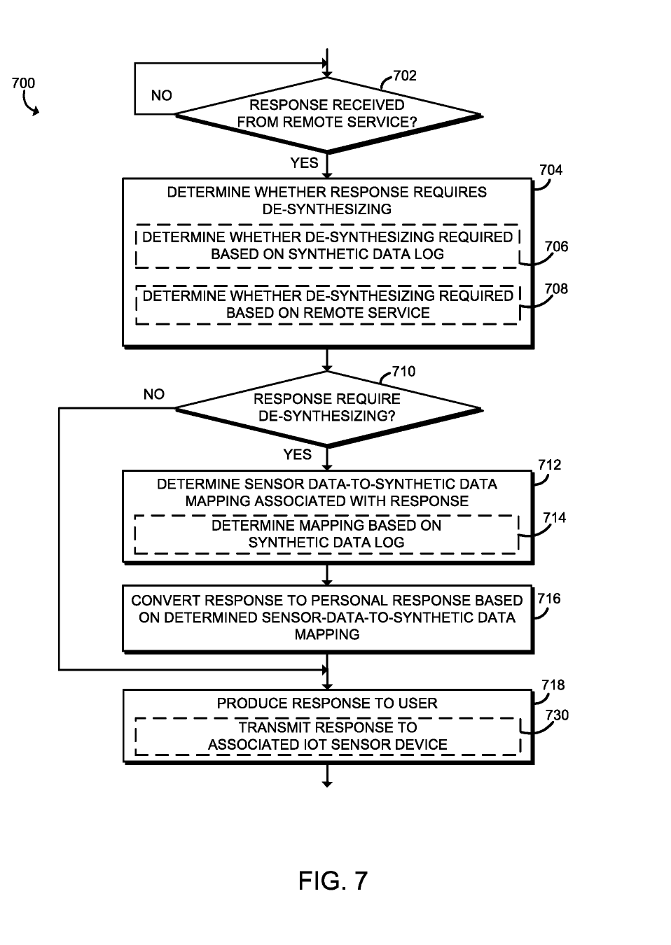

Referring now to FIG. 7, in use, the IOT gateway compute device 102 may execute a method 700 for de-synthesizing a response received from the remote service to generate a personal response that can be transmitted to the corresponding IOT sensor device 104. The method 700 begins with block 702 in which the IOT gateway compute device 102 determines whether a response from the remote service has been received. If the IOT gateway compute device 102 determines that a response has not been received, the method 700 loops back to block 702 to continue waiting for a response to be received from the remote service. If, however, the IOT gateway compute device 102 determines that a response has been received from the remote service, the method 700 advances to block 704.

In block 704, the IOT gateway compute device 102 determines whether the response requires de-synthesizing. As discussed above, de-synthesizing the response includes adding back the personal identifiable characteristics that were removed by the synthesizer 230. To do so, in some embodiments, in block 706, the IOT gateway compute device 102 may determine whether de-synthesizing is required based on the synthetic data log 246. In other embodiments, in block 708, the IOT gateway compute device 102 may determine whether de-synthesizing is required based on the remote service.

In block 710, if the IOT gateway compute device 102 determines that the response does not require de-synthesizing, the method 700 skips ahead to block 718 in which the IOT gateway compute device 102 produce the response to the user. If, however, the IOT gateway compute device 102 determines that the response requires de-synthesizing, the method 700 advances to block 712.

In block 712, the IOT gateway compute device 102 determines the sensor data-to-synthetic data mapping associated with the response. To do so, in some embodiments, the IOT gateway compute device 102 may determine the mapping based on the synthetic data log 246 in block 714. As discussed above, the synthetic data log 246 may include the synthetic data and the sensor data-to-synthetic data mapping used to generate the synthetic data. Accordingly, the IOT gateway compute device 102 may de-synthesize the response based on the mapping that was used to synthesize the raw sensor data to generate the synthetic data, which was transmitted to the remote service.

In block 716, the IOT gateway compute device 102 converts the response to a personal response based on the determined sensor data-to-synthetic data mapping. In block 718, the IOT gateway compute device 102 produces the response to the user. To do so, in some embodiments, the IOT gateway compute device 102 may transmit the response to the associated IOT sensor device 104 in block 730.

It should be appreciated that, while the technologies disclosed herein have been described in regard to the IOT gateway compute device 102, such technologies may be implanted on other compute devices, sensor nodes, and/or the like. For example, in some embodiments, an IOT sensor device 104 may execute the methods 300, 500, and/or 700. For example, some IOT sensor devices 104 may allow the user to adjust the privacy setting directly on that device 104 and generate synthetic data based on such privacy setting. As such, the technologies described herein are not limited to implementation on an IOT gateway but rather may be implemented on other compute devices, networking devices, sensor nodes, and/or the like.

### Examples

Illustrative examples of the technologies disclosed herein are provided below. An embodiment of the technologies may include any one or more, and any combination of, the examples described below.

Example 1 includes a compute device for anonymizing sensor data. The compute device includes a communicator to receive sensor data from a sensor of an Internet-of-Things (IOT) sensor cloud, wherein the sensor data is associated with a user; a data synthesis mapper to (i) determine whether to synthesize the sensor data and (ii) determine a mapping for the sensor data, wherein the mapping identifies one or more processes to be applied to the sensor data to convert the sensor data to synthetic data and wherein the synthetic data includes less personal identifiable characteristics of the user than the sensor data; and a sensor data synthesizer to synthesize the sensor data to generate the synthetic data using the determined mapping, wherein the communicator is further to transmit the synthetic data to a remote service for processing.

Example 2 includes the subject matter of Example 1, and wherein to receive sensor data from the sensor comprises to receive biometric data of the user from a sensor of the IOT sensor cloud.

Example 3 includes the subject matter of Example 1 or 2, wherein to receive biometric data of the user comprises to receive a captured image of the user from a sensor of the IOT sensor cloud.

Example 4 includes the subject matter of any of Examples 1-3, and wherein to receive biometric data of the user comprises to receive captured voice data of the user from a sensor of the IOT sensor cloud.

Example 5 includes the subject matter of any of Examples 1-4, and wherein to determine whether to synthesize the sensor data comprises to determine whether to synthesize the sensor data based on a privacy setting associated with the sensor or sensor data.

Example 6 includes the subject matter of any of Examples 1-5, and wherein to determine whether to synthesize the sensor data based on a privacy setting comprises to determine an identification indicator of the sensor and to compare the identification indicator to a privacy setting database to determine the privacy setting.

Example 7 includes the subject matter of any of Examples 1-6, and wherein to determine the mapping for the sensor data comprises to determine the mapping based on an identification indicator of the sensor.

Example 8 includes the subject matter of any of Examples 1-7, and wherein to determine the mapping for the sensor data comprises to determine the mapping based on a type of the sensor.

Example 9 includes the subject matter of any of Examples 1-8, and wherein to determine the mapping for the sensor data comprises to determine the mapping based on a type of the sensor data.

Example 10 includes the subject matter of any of Examples 1-9, and wherein to determine the mapping for the sensor data comprises to determine the mapping based on an identification of the remote service.

Example 11 includes the subject matter of any of Examples 1-10, and wherein to determine the mapping for the sensor data comprises to determine the mapping using a machine learning algorithm and previous mappings of sensor data used to convert other sensor data to synthetic data.

Example 12 includes the subject matter of any of Examples 1-11, and wherein to determine the mapping for the sensor data comprises to determine the mapping for the sensor data based on a combination of the sensor data and other sensor data from another sensor of the IOT sensor cloud, wherein the other sensor data is associated with the user.

Example 13 includes the subject matter of any of Examples 1-12, and wherein to determine the mapping for the sensor data comprises to validate the determined mapping with a remote service.

Example 14 includes the subject matter of any of Examples 1-13, and wherein to validate the determined mapping comprises to perform a negotiation protocol with the remote service to identify a mapping of the sensor data that produces synthetic data having a desired level of personal identifiable characteristics from the sensor data and that is usable by the remote service to perform a desired service.

Example 15 includes the subject matter of any of Examples 1-14, and wherein to synthesize the sensor data comprises to perform the one or more processes defined by the determined mapping on the sensor data.

Example 16 includes the subject matter of any of Examples 1-15, and wherein to synthesize the sensor data comprises to replace the sensor data with generic data of the same sensor data type as the sensor data.

Example 17 includes the subject matter of any of Examples 1-16, and wherein to replace the sensor data with generic data of the same sensor data type as the sensor data comprises to replace biometric data of the user with biometric data of another person.

Example 18 includes the subject matter of any of Examples 1-17, and wherein to synthesize the sensor data comprises to replace the sensor data with artificial sensor data of the same sensor data type as the sensor data.

Example 19 includes the subject matter of any of Examples 1-18, and wherein to synthesize the sensor data comprises to remove personal identifiable characteristics of the user from the sensor data.

Example 20 includes the subject matter of any of Examples 1-19, and wherein to synthesize the sensor data comprises to remove information from the sensor data not required by the remote service.

Example 21 includes the subject matter of any of Examples 1-20, and wherein the sensor data synthesizer is further to log the synthetic data to generate a synthetic data log that identifies the determined mapping used to generate the synthetic data.

Example 22 includes the subject matter of any of Examples 1-21, and wherein the communicator is further to receive a response from the remote service in response to the synthetic data; and the sensor data synthesizer is further to determine, in response to receiving the response from the remote service, whether the response requires de-synthesizing based on the synthetic data log; determine, in response to a determination that the response requires de-synthesizing, the mapping used to generate the synthetic data based on the synthetic data log; and convert the response to a personalized response to the user using the determined mapping.

Example 23 includes the subject matter of any of Examples 1-22, and further comprising a Trusted Execution Environment (TEE), and wherein the data synthesis mapper and the sensor data synthesizer are located in the TEE.

Example 24 includes a method for anonymizing sensor data comprising receiving, with a compute device, sensor data from a sensor of an Internet-of-Things (IOT) sensor cloud, wherein the sensor data is associated with a user; determining, by the compute device, whether to synthesize the sensor data; determining, by the compute device, a mapping for the sensor data, wherein the mapping identifies one or more processes to be applied to the sensor data to convert the sensor data to synthetic data and wherein the synthetic data includes less personal identifiable characteristics of the user than the sensor data; synthesizing, by the compute device, the sensor data to generate the synthetic data using the determined mapping; and transmitting the synthetic data to a remote service for processing.

Example 25 includes the subject matter of Example 24, and wherein receiving sensor data from the sensor comprises receiving biometric data of the user from a sensor of the IOT sensor cloud.

Example 26 includes the subject matter of Example 24 or 25, and wherein receiving biometric data of the user comprises receiving a captured image of the user from a sensor of the IOT sensor cloud.

Example 27 includes the subject matter of any of Examples 24-26, and wherein receiving biometric data of the user comprises receiving captured voice data of the user from a sensor of the IOT sensor cloud.

Example 28 includes the subject matter of any of Examples 24-27, and wherein determining whether to synthesize the sensor data comprises determining whether to synthesize the sensor data based on a privacy setting associated with the sensor or sensor data.

Example 29 includes the subject matter of any of Examples 24-28, and wherein determining whether to synthesize the sensor data based on a privacy setting comprises determining an identification indicator of the sensor and comparing the identification to a privacy setting database to determine the privacy setting.

Example 30 includes the subject matter of any of Examples 24-29, and wherein determining the mapping for the sensor data comprises determining the mapping based on an identification indicator of the sensor.

Example 31 includes the subject matter of any of Examples 24-30, and wherein determining the mapping for the sensor data comprises determining the mapping based on a type of the sensor.

Example 32 includes the subject matter of any of Examples 24-31, and wherein determining the mapping for the sensor data comprises determining the mapping based on a type of the sensor data.

Example 33 includes the subject matter of any of Examples 24-32, and wherein determining the mapping for the sensor data comprises determining the mapping based on an identification of the remote service.

Example 34 includes the subject matter of any of Examples 24-33, and wherein determining the mapping for the sensor data comprises determining the mapping using a machine learning algorithm and previous mappings of sensor data used to convert other sensor data to synthetic data.

Example 35 includes the subject matter of any of Examples 24-34, and wherein determining the mapping for the sensor data comprises determining the mapping for the sensor data based on a combination of the sensor data and other sensor data from another sensor of the IOT sensor cloud, wherein the other sensor data is associated with the user.

Example 36 includes the subject matter of any of Examples 24-35, and determining the mapping for the sensor data comprises validating the determined mapping with a remote service.

Example 37 includes the subject matter of any of Examples 24-36, and wherein validating the determined mapping comprises performing a negotiation protocol with the remote service to identify a mapping of the sensor data that produces synthetic data having a desired level of personal identifiable characteristics from the sensor data and that is usable by the remote service to perform a desired service.

Example 38 includes the subject matter of any of Examples 24-37, and wherein synthesizing the sensor data comprises performing the one or more processes defined by the determined mapping on the sensor data.

Example 39 includes the subject matter of any of Examples 24-38, and wherein synthesizing the sensor data comprises replacing the sensor data with generic data of the same sensor data type as the sensor data.

Example 40 includes the subject matter of any of Examples 24-39, and wherein replacing the sensor data with generic data of the same sensor data type as the sensor data comprises replacing biometric data of the user with biometric data of another person.

Example 41 includes the subject matter of any of Examples 24-40, and wherein synthesizing the sensor data comprises replacing the sensor data with artificial sensor data of the same sensor data type as the sensor data.

Example 42 includes the subject matter of any of Examples 24-41, and wherein synthesizing the sensor data comprises removing personal identifiable characteristics of the user from the sensor data.

Example 43 includes the subject matter of any of Examples 24-42, and wherein synthesizing the sensor data comprises removing information from the sensor data not required by the remote service.

Example 44 includes the subject matter of any of Examples 24-43, and further comprising logging the synthetic data to generate a synthetic data log that identifies the determined mapping used to generate the synthetic data.

Example 45 includes the subject matter of any of Examples 24-44, and further comprising receiving, by the compute device, a response from the remote service in response to the synthetic data; determining, by the compute device, whether the response requires de-synthesizing based on the synthetic data log; determining, by the compute device and in response to a determination that the response requires de-synthesizing, the mapping used to generate the synthetic data based on the synthetic data log; and converting the response to a personalized response to the user using the determined mapping.

Example 46 includes the subject matter of any of Examples 24-45, and wherein determining whether to synthesize the sensor data, determining a mapping for the sensor data, and synthesizing, by the compute device, the sensor data are performed in a Trusted Execution Environment of the compute device.

Example 47 includes one or more machine-readable storage media comprising a plurality of instructions stored thereon that, when executed, causes a compute device to perform the method of any of Examples 24-46.

Example 48 includes a compute device for anonymizing sensor data comprising a communication subsystem to receive sensor data from a sensor of an Internet-of-Things (IOT) sensor cloud, wherein the sensor data is associated with a user; means for determining whether to synthesize the sensor data; means for determining a mapping for the sensor data, wherein the mapping identifies one or more processes to be applied to the sensor data to convert the sensor data to synthetic data and wherein the synthetic data includes less personal identifiable characteristics of the user than the sensor data; means for synthesizing, by the compute device, the sensor data to generate the synthetic data using the determined mapping, wherein the communication subsystem is further to transmit the synthetic data to a remote service for processing.

Example 49 includes the subject matter of Example 48, and wherein the means for receiving sensor data from the sensor comprises means for receiving biometric data of the user from a sensor of the IOT sensor cloud.

Example 50 includes the subject matter of Example 48 or 49, and wherein the means for receiving biometric data of the user comprises means for receiving a captured image of the user from a sensor of the IOT sensor cloud.

Example 51 includes the subject matter of any of Examples 48-50, and wherein the means for receiving biometric data of the user comprises means for receiving captured voice data of the user from a sensor of the IOT sensor cloud.

Example 52 includes the subject matter of any of Examples 48-51, and wherein the means for determining whether to synthesize the sensor data comprises means for determining whether to synthesize the sensor data based on a privacy setting associated with the sensor or sensor data.

Example 53 includes the subject matter of any of Examples 48-52, and wherein the means for determining whether to synthesize the sensor data based on a privacy setting comprises means for determining an identification indicator of the sensor and comparing the identification to a privacy setting database to determine the privacy setting.

Example 54 includes the subject matter of any of Examples 48-53, and wherein the means for determining the mapping for the sensor data comprises means for determining the mapping based on an identification indicator of the sensor.

Example 55 includes the subject matter of any of Examples 48-54, and wherein the means for determining the mapping for the sensor data comprises means for determining the mapping based on a type of the sensor.

Example 56 includes the subject matter of any of Examples 48-55, and wherein the means for determining the mapping for the sensor data comprises means for determining the mapping based on a type of the sensor data.

Example 57 includes the subject matter of any of Examples 48-56, and wherein the means for determining the mapping for the sensor data comprises means for determining the mapping based on an identification of the remote service.

Example 58 includes the subject matter of any of Examples 48-57, and wherein the means for determining the mapping for the sensor data comprises means for determining the mapping using a machine learning algorithm and previous mappings of sensor data used to convert other sensor data to synthetic data.

Example 59 includes the subject matter of any of Examples 48-58, and wherein the means for determining the mapping for the sensor data comprises means for determining the mapping for the sensor data based on a combination of the sensor data and other sensor data from another sensor of the IOT sensor cloud, wherein the other sensor data is associated with the user.

Example 60 includes the subject matter of any of Examples 48-59, and wherein the means for determining the mapping for the sensor data comprises means for validating the determined mapping with a remote service.

Example 61 includes the subject matter of any of Examples 48-60, and wherein the means for validating the determined mapping comprises means for performing a negotiation protocol with the remote service to identify a mapping of the sensor data that produces synthetic data having a desired level of personal identifiable characteristics from the sensor data and that is usable by the remote service to perform a desired service.

Example 62 includes the subject matter of any of Examples 48-61, and wherein the means for synthesizing the sensor data comprises means for performing the one or more processes defined by the determined mapping on the sensor data.

Example 63 includes the subject matter of any of Examples 48-62, and wherein the means for synthesizing the sensor data comprises means for replacing the sensor data with generic data of the same sensor data type as the sensor data.

Example 64 includes the subject matter of any of Examples 48-63, and wherein the means for replacing the sensor data with generic data of the same sensor data type as the sensor data comprises means for replacing biometric data of the user with biometric data of another person.

Example 65 includes the subject matter of any of Examples 48-64, and wherein the means for synthesizing the sensor data comprises means for replacing the sensor data with artificial sensor data of the same sensor data type as the sensor data.

Example 66 includes the subject matter of any of Examples 48-65, and wherein the means for synthesizing the sensor data comprises means for removing personal identifiable characteristics of the user from the sensor data.

Example 67 includes the subject matter of any of Examples 48-66, and wherein the means for synthesizing the sensor data comprises means for removing information from the sensor data not required by the remote service.

Example 68 includes the subject matter of any of Examples 48-67, and further comprising means for logging the synthetic data to generate a synthetic data log that identifies the determined mapping used to generate the synthetic data.

Example 69 includes the subject matter of any of Examples 48-68, and further comprising means for receiving a response from the remote service in response to the synthetic data; means for determining whether the response requires de-synthesizing based on the synthetic data log; means for determining, in response to a determination that the response requires de-synthesizing, the mapping used to generate the synthetic data based on the synthetic data log; and means for converting the response to a personalized response to the user using the determined mapping.

Example 70 includes the subject matter of any of Examples 48-69, and wherein the means for determining whether to synthesize the sensor data, means for determining a mapping for the sensor data, and means for synthesizing the sensor data are located in a Trusted Execution Environment of the compute device.

1. A compute device for anonymizing sensor data, the compute device comprising:
a communicator to receive sensor data from a sensor of an Internet-of-Things (IOT) sensor cloud, wherein the sensor data is associated with a user;
a data synthesis mapper to (i) determine whether to synthesize the sensor data and (ii) determine a mapping for the sensor data, wherein the mapping identifies one or more processes to be applied to the sensor data to convert the sensor data to synthetic data and wherein the synthetic data includes less personal identifiable characteristics of the user than the sensor data; and
a sensor data synthesizer to synthesize the sensor data to generate the synthetic data using the determined mapping,
wherein the communicator is further to transmit the synthetic data to a remote service for processing.

2. The compute device of claim 1, wherein to determine whether to synthesize the sensor data comprises to determine whether to synthesize the sensor data based on a privacy setting associated with the sensor or sensor data.

3. The compute device of claim 2, wherein to determine whether to synthesize the sensor data based on a privacy setting comprises to determine an identification indicator of the sensor and to compare the identification indicator to a privacy setting database to determine the privacy setting.

4. The compute device of claim 1, wherein to determine the mapping for the sensor data comprises to determine the mapping based on at least one of: (i) an identification indicator of the sensor, (ii) a type of the sensor, (iii) a type of the sensor data, or (iv) an identification of the remote service.

5. The compute device of claim 1, wherein to determine the mapping for the sensor data comprises to determine the mapping for the sensor data based on a combination of the sensor data and other sensor data from another sensor of the IOT sensor cloud, wherein the other sensor data is associated with the user.

6. The compute device of claim 1, wherein to determine the mapping for the sensor data comprises to perform a negotiation protocol with the remote service to identify a mapping of the sensor data that produces synthetic data having a desired level of personal identifiable characteristics from the sensor data and that is usable by the remote service to perform a desired service.

7. The compute device of claim 1, wherein to synthesize the sensor data comprises to replace the sensor data with (i) generic data of the same sensor data type as the sensor data or (ii) artificial sensor data of the same sensor data type as the sensor data.

8. The compute device of claim 1, wherein to synthesize the sensor data comprises to remove personal identifiable characteristics of the user from the sensor data.

9. The compute device of claim 1, wherein to synthesize the sensor data comprises to remove information from the sensor data not required by the remote service.

10. A method for anonymizing sensor data comprising:
receiving, with a compute device, sensor data from a sensor of an Internet-of-Things (IOT) sensor cloud, wherein the sensor data is associated with a user;
determining, by the compute device, whether to synthesize the sensor data;
determining, by the compute device, a mapping for the sensor data, wherein the mapping identifies one or more processes to be applied to the sensor data to convert the sensor data to synthetic data and wherein the synthetic data includes less personal identifiable characteristics of the user than the sensor data;
synthesizing, by the compute device, the sensor data to generate the synthetic data using the determined mapping; and
transmitting the synthetic data to a remote service for processing.

11. The method of claim 10, wherein determining whether to synthesize the sensor data comprises determining whether to synthesize the sensor data based on a privacy setting associated with the sensor or sensor data.

12. The method of claim 11, wherein determining whether to synthesize the sensor data based on a privacy setting comprises determining an identification indicator of the sensor and comparing the identification to a privacy setting database to determine the privacy setting.

13. The method of claim 10, wherein determining the mapping for the sensor data comprises determining the mapping based on at least one of: (i) an identification indicator of the sensor, (ii) a type of the sensor, (iii) a type of the sensor data, or (iv) an identification of the remote service.

14. The method of claim 10, wherein determining the mapping for the sensor data comprises determining the mapping for the sensor data based on a combination of the sensor data and other sensor data from another sensor of the TOT sensor cloud, wherein the other sensor data is associated with the user.

15. The method of claim 10, wherein determining the mapping for the sensor data comprises performing a negotiation protocol with the remote service to identify a mapping of the sensor data that produces synthetic data having a desired level of personal identifiable characteristics from the sensor data and that is usable by the remote service to perform a desired service.

16. The method of claim 10, wherein synthesizing the sensor data comprises replacing the sensor data with (i) generic data of the same sensor data type as the sensor data or (ii) artificial sensor data of the same sensor data type as the sensor data.

17. The method of claim 10, wherein synthesizing the sensor data comprises removing personal identifiable characteristics of the user from the sensor data.

18. One or more machine-readable storage media comprising a plurality of instructions stored thereon that, when executed, causes a compute device to:
receive sensor data from a sensor of an Internet-of-Things (TOT) sensor cloud, wherein the sensor data is associated with a user;
determine whether to synthesize the sensor data;
determine a mapping for the sensor data, wherein the mapping identifies one or more processes to be applied to the sensor data to convert the sensor data to synthetic data and wherein the synthetic data includes less personal identifiable characteristics of the user than the sensor data;
synthesize the sensor data to generate the synthetic data using the determined mapping; and
transmit the synthetic data to a remote service for processing.

19. The one or more machine-readable storage media of claim 18, wherein to determine whether to synthesize the sensor data comprises to determine whether to synthesize the sensor data based on a privacy setting associated with the sensor or sensor data.

20. The one or more machine-readable storage media of claim 19, wherein to determine whether to synthesize the sensor data based on a privacy setting comprises to determine an identification indicator of the sensor and comparing the identification to a privacy setting database to determine the privacy setting.

21. The one or more machine-readable storage media of claim 18, wherein to determine the mapping for the sensor data comprises to determine the mapping based on at least one of: (i) an identification indicator of the sensor, (ii) a type of the sensor, (iii) a type of the sensor data, or (iv) an identification of the remote service.

22. The one or more machine-readable storage media of claim 18, wherein to determine the mapping for the sensor data comprises to determine the mapping for the sensor data based on a combination of the sensor data and other sensor data from another sensor of the TOT sensor cloud, wherein the other sensor data is associated with the user.

23. The one or more machine-readable storage media of claim 18, wherein to determine the mapping for the sensor data comprises to perform a negotiation protocol with the remote service to identify a mapping of the sensor data that produces synthetic data having a desired level of personal identifiable characteristics from the sensor data and that is usable by the remote service to perform a desired service.

24. The one or more machine-readable storage media of claim 18, wherein to synthesize the sensor data comprises to replace the sensor data with (i) generic data of the same sensor data type as the sensor data or (ii) artificial sensor data of the same sensor data type as the sensor data.

25. The one or more machine-readable storage media of claim 18, wherein to synthesize the sensor data comprises to remove personal identifiable characteristics of the user from the sensor data.
